(19) United States
(12) Patent Application Publication
(10) Pub. No.: US 2014/0130111 A1
(43) Pub. Date: May 8, 2014

(54) AGENT-BASED COMMUNICATION SERVICE QUALITY MONITORING AND DIAGNOSTICS

(71) Applicant: Tollgrade Communications, Inc., Cranberry Twp., PA (US)

(72) Inventors: Gregory M. Nulty, Reston, VA (US); Manoj Sindhwani, Oak Hill, VA (US)

(73) Assignee: Tollgrade Communications, Inc., Cranberry Twp., PA (US)

(21) Appl. No.: 14/072,876

(22) Filed: Nov. 6, 2013

Related U.S. Application Data
(60) Provisional application No. 61/723,186, filed on Nov. 6, 2012.

(51) Int. Cl. H04N 17/00; H04N 21/61

(52) U.S. Cl. CPC H04N 17/004; H04N 21/6168; H04N 21/6118; H04N 21/6125
USPC 725/107

(57) ABSTRACT

Diagnosis of a service affecting condition can be performed by obtaining first diagnostic information from a first software agent installed on a first communication enabled device within a customer premises and second diagnostic information from a second software agent installed on a second communication enabled device within the customer premises. The first and second diagnostic information can be processed to determine information regarding a service affecting condition.

### CROSS-REFERENCE TO RELATED APPLICATIONS

This application claims the benefit under 35 U.S.C. 119(e) of U.S. Provisional Application 61/723,186, filed on Nov. 6, 2012, titled “AGENT-BASED COMMUNICATION SERVICE QUALITY MONITORING AND DIAGNOSTICS,” which is hereby incorporated by reference in its entirety.

### BACKGROUND

Residential customers may receive communication services, such as telephone or Internet access, from various service providers such as cable or DSL service providers. These services may be distributed to multiple customers through service provider networks that carry signals to each customer's premises. At each customer's premises, wiring is often connected to the network to make such services available at multiple locations or through multiple devices.

These services are made available through various types of communication enabled devices that can use and/or generate information conveyed over the network as part of a communication service. For example, when the information conveyed is audio-video content, the communication enabled device may be a television that displays the audio-video content. In other scenarios, the communication enabled device may resemble a telephone, a radio or other device that predominately operates based on audio information. In yet other scenarios, the information may be digital data, and the communication enabled device may be a computer, electronic reader or other computerized appliance that uses or generates digital data.

Communication services can be degraded or interrupted due to faults in either the network or the wiring local to the customer's premises. The service provider is generally responsible for faults that occur in the network. However, the customer is usually responsible for repairing faults within the customer's premises. Moreover, a customer may experience poor service for many reasons, such as excessive electrical noise or heavy network traffic, that are not attributable to the service provider.

Nonetheless, when problems occur with the customer's service, the customer may call the service provider for assistance, whether the problem is caused by a problem at the customer premises or within the service provider's network. An automated system may assist the user over the telephone. If the customer is unable to resolve the problem, he/she may request to speak with a customer support representative. In some circumstances, the customer support representative may initiate a wiring test using a line test system that controls a test head to test the service provider network. Though, if the customer support representative determines that the cause of the problem is not within the service provider's network or cannot identify the source of the problem, it may be necessary for the service provider to send a technician to the customer's residence to resolve the problem.

Dispatching a technician can be costly for the service provider. In some instances, the service provider will impose a charge on the customer for dispatching a technician to the customer's premises, which can also be costly or frustrating for the customer. Even if a technician is not dispatched, the cost of maintaining a customer support center with personnel and test systems to respond to customer calls can be costly for the service provider.

### SUMMARY

Some embodiments relate to a method of diagnosing a service affecting condition. The method includes obtaining first diagnostic information from a first software agent installed on a first communication enabled device within a customer premises and second diagnostic information from a second software agent installed on a second communication enabled device within the customer premises. The method also includes processing the first and second diagnostic information to determine information regarding a service affecting condition.

In another aspect, the method alternatively or additionally may involve collecting diagnostic information at a central agent from one or more other agents within the customer premises and/or a service provider's network. Based on the collected diagnostic information, the central agent may identify a service affecting condition. Such information may be collected automatically, such as during ongoing network monitoring. Alternatively or additionally, the information may be collected in response to express user input indicating a service affecting condition or detection of a condition which may indicate that that the user is experiencing a problem. The condition, for example, may be detected by an agent associated with a device that controls presentation of audio-video information (such as television programming) or digital data, such as may be conveyed over the internet, and may be slow performance or conditions of packetized traffic that lead to a poor customer perception of audio and/or video information.

Some embodiments relate to a system for diagnosing a service affecting condition. The system includes a computing device configured to receive first diagnostic information from a first software agent installed on a first communication enabled device within a customer premises and second diagnostic information from a second software agent installed on a second communication enabled device within the customer premises. The computing device is configured to process the first and second diagnostic information to determine information regarding a service affecting condition.

Some embodiments relate to use of a software agent to obtain diagnostic information from a communication enabled device configured for providing some aspect of a communication service within a customer's premises. The software agent may execute on circuitry within the communication enabled device and access information collected or generated during operation of the communication enabled device. This information may be used to detect, diagnose and/or repair of service affecting conditions. Such detection, diagnosis and/or repair may be performed by a single agent or through interaction of an agent with one or more other agents, computerized devices and/or other test devices.

In one aspect, the first and second diagnostic information may be received from the first and second software agents at a third agent installed on a third communication enabled device within the customer premises.

In one aspect, the first and second diagnostic information may be processed by the third agent.

In one aspect, the first and second diagnostic information may be received from the third agent and processed within a service provider network.

In one aspect, a notification may be provided to a customer regarding a diagnosed service affecting condition.

Some embodiments relate to a method for diagnosing a service affecting condition. The method includes obtaining diagnostic information using a software agent installed on a communication enabled device within a customer premises, processing the diagnostic information to determine information regarding a service affecting condition, and triggering a test of a local network at the customer premises based upon the information regarding the service affecting condition.

In one aspect, the test may be a test of an electrical conductor within or leading to the customer premises.

In one aspect, the test may be a test of communication between communication enabled devices within the customer premises.

Some embodiments relate to a computer readable medium for performing one or more of the above methods.

The foregoing summary is provided by way of illustration and is not intended to be limiting.

### BRIEF DESCRIPTION OF DRAWINGS

FIG. 1 schematically illustrates an example of a customer premises having communication-enabled devices with agents installed thereon for collecting and/or analyzing diagnostic information, according to some embodiments.

FIG. 2A shows a flowchart of a method of diagnosing a service affecting condition, according to some embodiments.

FIG. 2B shows another flowchart of a method of diagnosing a service-affecting condition, according to some embodiments.

FIG. 3 shows a diagram of a system in which a test device and/or a software agent A may communicate with one or more other devices in a service provider network to provide additional functionality to aid in testing to detect or troubleshoot service affecting conditions.

### DETAILED DESCRIPTION

The techniques described herein relate generally to detecting and diagnosing the cause of degradation in communication service quality by obtaining service-related information at the customer premises.

As described in U.S. patent application Ser. Nos. 13/492,658, 13/492,703, and 13/492,640, filed on Jun. 8, 2012, each of which is hereby incorporated by reference in its entirety, it was recognized and appreciated that existing techniques for testing wiring by a service provider may be insufficient for detecting wiring faults at a customer's location. In particular, noise or interference problems that occur at high frequencies may be difficult to detect from a remote location. A significant reduction in service related costs can be achieved by a service provider that has a customer service system that supports interaction with test devices at customer premises. Customers of a communication service may have an improved user experience through such a test device that is simple to install and operate at the customer's premises. For the service provider, there may be a reduction in the need for maintaining support personnel and test equipment for responding to customer complaints about problems that ultimately are traced to faults in customer premises wiring. For customers, the frustration of interacting with a service provider only to ultimately learn that problems with the customer's service are caused by the customer's own wiring may be reduced. Costs of an unnecessary dispatch of a technician to the customer's premises might be avoided. Even in scenarios where dispatch of a technician is required, the surprise of being required to pay the service provider for that dispatch may be eliminated, which may ultimately improve the customer's experience.

The present inventors have recognized and appreciated that customers may use several different devices at the customer's premises that are capable of communicating over a network. When a customer experiences problems with quality of service, tests of wiring at the customer premises may not be sufficient to pinpoint the root cause of the service problem. Accordingly, the present inventors have appreciated that it would be desirable to obtain additional information regarding the performance of home networking to enable detecting or localizing the root cause of the service problem.

As discussed above, customers may use several different communication enabled devices at the customer's premises that are capable of communicating over a network (e.g., a local network and/or the Internet). Degradation in communication service quality may be caused by any of a variety of sources within the customer premises or outside of the customer premises, such as failure or reduction in performance of a device located at the customer premises, a failure or reduction in performance of a device within the service provider network outside of the customer premises, a wiring fault within or outside of the customer premises, RF interference with wireless communications at the customer premises, improper configuration of a device, network operating conditions, etc.

Service problems arising within the customer premises may be particularly difficult to diagnose, as different customer premises may include different types of communication-enabled devices, and may have different local network configurations. Moreover, some of the conditions may occur or be noticed by a customer only under certain conditions. For example, transient noise may create intermittent problems. As another example, a service-affecting condition in a network may cause random delays in data packet transmission. These random delays lead to jitter which may be noticeable in some scenarios, such as when the packets convey video data for a very dynamic program, such as a sports broadcast. However, the same amount of jitter may be unnoticed by a customer when the packets carry digital data for a computer or even video data for a relative static program, such as a talk show. Accordingly, diagnosing the root cause of a quality of service or quality of experience issue that may be the result of device or network malfunction, or other service affecting condition, within the customer premises can be a challenging problem.

In an exemplary scenario, a customer may use a device such as an IPTV (Internet Protocol Television) to watch streaming video over the Internet. At some point, degradation in service quality may occur that produces pixelization or jitter in the video. It would be desirable to diagnose the source of the service problem so that it can be corrected, possibly even without affirmative user action.

Such a service problem may be caused by any of a variety of devices in the customer premises, such as the IPTV, a router or hub to which the IPTV is connected, or the customer's modem, for example. Alternatively, as discussed above, the problem may arise in wiring within or outside of the customer premises. As yet a further possibility, the problem may arise as a result of a failed hardware component in a set top box connected to the IPTV or network loading.

As discussed above, test techniques may be used to detect wiring faults. However, if the problem arises at a device within the customer premises or as a result of network operating conditions, the service provider may not be capable of determining which of the devices within the customer premises is the cause of the problem. Accordingly, if the customer calls their service provider for assistance in resolving the issue, the operator may be unable to solve the problem. The service provider may need to send a technician to the customer's location, which may lead to additional expense for the customer or service provider. There is a possibility that the quality of service problem may not be diagnosed accurately by the service provider.

Moreover, conventional test approaches that rely on the customer to initiate diagnosis of a problem mean that the customer has already recognized and likely already been inconvenienced by whatever problem exists. Such tests also have limited ability to detect intermittent faults. In accordance with some embodiments of the techniques described herein, an agent installed in a communication enabled device used in delivering a service may access information about operating conditions of the device and may determine whether those operating conditions are likely to be perceived as representing poor quality by the user. In this way, an agent can obtain information related to quality of service as well as quality of user experience. Quality of experience information, because it can be related to a device on which the agent is installed, can reflect the manner in which the user experiences various network conditions when using that device.

For example, a communication device that is set top box for a television may have processing circuitry that is adapted to execute third party widgets or other software programs. A diagnostic agent can be written for such a device using these known techniques. Such an agent may access parameters of communication measured and recorded by communications hardware in the set top box. The agent may report this information to other components used for detecting, diagnosing and/or repairing network conditions.

The agent may interpret raw communication parameter information based on the intended or actual use of the communication enabled device on which it is installed. For example, communication hardware in a set top box may measure communication parameters such as loss, delay or jitter associated with received packets. An agent executing on the set top box may also access information that will enable the classification of particular values of these parameters as representing adequate or degraded performance based on the designed or actual use of the set top box. For example, the set top box may be a high definition TV set top box. In such a scenario, the agent may classify packet loss or jitter above a threshold as a service affecting condition. An agent on another communication device, such as a set top box intended only for low definition TV, may apply a higher threshold before indicating that a service affecting condition exists.

Other agents, configured for operation on other communication enabled devices, may apply other criteria to determine when particular parameters represent service affecting conditions because they are likely to impact a user experience. For example, an agent on a device used in providing VoIP services may signal a service affecting condition if a relatively low level of packet jitter is detected, but may not respond in the same way to delay. In contrast, a device that uses the communication service to send commands from users and receive responses may use thresholds that indicate service affecting conditions for relatively low levels of delay, but not high levels of packet jitter.

Moreover, the criteria applied to indicating whether a service affecting condition exists may be adjusted dynamically based on actual use of the communication enabled device. In a scenario in which a communication device is being used to download or buffer a file, parameters indicating a certain level of jitter, delay or out of order packets may not be deemed to represent a service affecting condition, because a user may be unaware of the condition. Conversely, when the same device is used to display in real time streaming audio-video content, lower levels of one or more of these parameters may be deemed to be a service affecting condition.

Also, the agent may combine measured parameters of network communication with user action data. The user action data may indicate user actions in operating a communication enabled device in which an agent is installed. As an example of user action data, an agent in a set top box may access information indicating user input to the set top box. As a specific example, user input may be in the form of a command to tune to a particular channel. Measured communications parameters may indicate no data on that channel. The combination of the user action data and the measured parameters may be used in detecting and/or diagnosing a service affecting condition.

In some embodiments, the user action data may be used without the measured parameters and may be used for purposes other than diagnosis. For example, in some scenarios, the agents may gather statistics that are communicated to a central location separate from diagnostic information. Such statistics, for example, may indicate viewer activity.

Accordingly, in accordance with the techniques described herein, diagnosis of the cause of degradation in quality of service and/or quality of experience may be facilitated through the use of software agents installed on one or more communication enabled devices at the customer premises. In some embodiments, a software agent installed in a communication enabled device may gather information (e.g., diagnostic information) regarding the operation of the communication enabled device or a communication service provided to the communication enabled device. For example, a software agent may obtain communication related parameters measured by hardware components implementing a network interface for the communication enabled device, such as packet loss rate, for example. As another example, a software agent may obtain diagnostic information regarding the operation of one or more components of the communication enabled device. For example, a component implementing an HDMI interface may output a control signal indicating that it was unable to negotiate a connection with a display device. Such a signal may be captured as diagnostic information. As another example, an agent in a set top box may interact with control components making up the set top box to determine that a particular channel could not be accessed or, when accessed did not contain audio-video information. Such determination may be made in any suitable way, including based on an analysis of measured parameters. For example, the received packet rate when tuned to a channel may be too slow to adequately display audio-video information, based on which an agent may infer a potential problem in accessing the channel. As a further example, diagnostic information also may include self-test information. Such information may enable verifying that components of the communication enabled device are functioning properly.

Moreover, an agent installed on a communication enabled device may control the device to act as a test device for use in collecting data about conditions on a network to which the device is attached. When operated in this mode, the agent may measure network traffic statistics, for example. Alternatively or additionally, the agent may control the communication enabled device to interact with other devices, which may be configured as test devices, connected to the network. As examples of such tests, an agent may control a communication enabled device to exchange data with another device as part of a connectivity test. Though, any suitable parameters of the network, including of the premises wiring that forms a physical layer for the network, may be measured and used as diagnostic information. In some embodiments, agents may have “administrator” level security permissions, which may enable the agent to perform a soft reset of a device.

Diagnostic processing may be performed based at least in part on the diagnostic information collected by one or more agents to detect and/or diagnose a quality of service and/or quality of experience problem. For example, in some embodiments a rule-based analysis may be performed to produce a diagnosis based upon the diagnostic information. The diagnostic information may include a measured performance of a device or communication service. The measured performance may be checked (e.g., by comparison to a threshold) to determine whether the measured performance is within an acceptable range.

Diagnostic processing may be performed by any suitable computing device, such as a device at the customer premises or a device within the service provider network. In some embodiments, diagnostic processing may be performed by one or more software agents running on the communication enabled devices at the customer's location. For example, diagnostic processing may be performed by a software agent that obtained the diagnostic information and/or by another software agent running on another device at the customer premises. Advantageously, the software agents may be configured to communicate with one another to exchange information such as diagnostic information, results determined based on processing the diagnostic information, and/or other information, such test results. Alternatively or additionally, diagnostic information may be sent from one or more software agents to the service provider network such that diagnostic processing can be performed by a device within the service provider network. In such a case, one or more of the software agents may be configured to communicate with the service provider network to exchange information such as diagnostic information, processing results and/or test results.

In some embodiments, an agent executing on a communication enabled device may operate as a diagnostic controller. Such an agent may perform diagnostic tests and/or control other agents to perform tests and/or process test results from one or more agents. The agent acting as a diagnostic controller may communicate with other agents deployed in the network and/or with the service provider network. The diagnostic controller can collect diagnostic information from the other agents as well as issue commands, such as to trigger the agents to perform tests. By communicating with devices within the service provider network, the diagnostic controller may obtain information about service affecting conditions in the service provider's network, which might in turn impact the customer's experience. Such information may be used, for example, as part of a diagnostic algorithm executed by the diagnostic controller to rule out problems at the customer premises. Alternatively, the diagnostic controller may communicate information to devices within the service provider network. Such communication may be used in diagnostic algorithms run by the service provider devices to rule out problems within the service provider network when a customer complains of a service problem.

The diagnostic controller may be implemented on any suitable network-enabled device. In some embodiments, the diagnostic controller may be implemented as part of a network gateway device, implementing a gateway between a network within a customer premises and the service provider network. Such a device, for example, may be a modem or a router. In other embodiments, the diagnostic controller may be implemented on a computing device that is connected to the network. Though, it should be appreciated that the diagnostic controller might be implemented on any device connected to the network. Moreover, it is not necessary that a diagnostic controller be present. In some embodiments, the functions of the diagnostic controller may be distributed across multiple agents or implemented in other components.

Regardless of whether a diagnostic controller is used, providing software agents on communication enabled devices at the customer premises may facilitate diagnosing the cause of a service affecting condition. In some embodiments, processing of diagnostic information to detect a service affecting condition may be performed automatically without the customer being required to initiate such processing. For example, software agents may run autonomously on communication enabled devices to gather diagnostic information and/or perform diagnostic processing on an ongoing basis. Alternatively or additionally, the agents may be periodically polled by a diagnostic controller to gather and/or report diagnostic information. When a service affecting condition is detected, a notification may be provided to the customer and/or the service provider. For example, the customer may be notified by display of a notification on the customer's television or computing device.

Such notification may be provided in any suitable way. In some embodiments, an agent may control a communication enabled device that includes a user interface, such as a television set top box that is coupled to a television, to provide the notification through the existing user interface for the communication enabled device. Alternatively or additionally, an e-mail or text message may be sent to the customer with the notification. The service provider may notify the customer via the telephone. To assist the customer in resolving the problem, the customer may be provided with information enabling the customer to resolve the service-affecting condition. For example, the customer may be instructed to restart, reconnect or replace a malfunctioning device. Additional techniques for guiding the customer to a resolution of a service affecting condition are discussed herein.

In some embodiments, diagnostic processing of the diagnostic information may trigger one or more tests to be performed. As an example, if the diagnostic information shows that communication enabled devices at the customer premises are operating within an acceptable performance range, testing may be triggered to determine whether another service affecting condition exists. For example, one or more software agents may run diagnostic tests to test communications between respective communication enabled devices, and/or may run communication tests with devices outside of the customer premises (e.g., on the Internet), such as speed test or a ping test, for example. In some cases electrical testing may be performed on one or more conductor(s) (e.g., wiring or cables) through with the communication service is provided to determine whether a fault or other service affecting condition is present. As another example, measurements of signal components present on conductor(s) may be performed, such as QLN (Quiet Line Noise) measurements and/or FDR (Frequency Domain Reflectometry) measurements. Such electrical tests may be performed by a dedicated test device located at the customer premises, and/or by a device residing in the service provider network, as discussed in further detail below.

In some cases, near real-time information may be provided to the service provider, allowing an operator to determine the quality of service experienced by the customer and/or discover imminent failure situations, allowing an operator to determine appropriate corrective action. In some cases, the customer may be notified that the service provider is aware of a service affecting condition and that appropriate action is being taken, such as testing, diagnostic processing and/or corrective action, so that the customer may not need to call the service provider or otherwise notify the service provider of the problem. Such techniques can increase customer satisfaction and reduce the quantity of calls or other service inquiries received by the service provider.

Notification may be provided to the service provider in any suitable way. In some embodiments, the service provider network may include a test head. Such a test head may be configured to test wiring or other components in the service provider network. Accordingly, the test head may be coupled, through the service provider network, to the customer premises network such that devices on the customer premises network can communicate with the test head, using in-band or out of band signaling. An agent on a communication enabled device or diagnostic controller thus has a path to communicate with a test head. Such a path may be used for reporting diagnostic information to the service provider or receiving network condition information from the service provider network. Though, it should be appreciated that any suitable communication mechanism may be used.

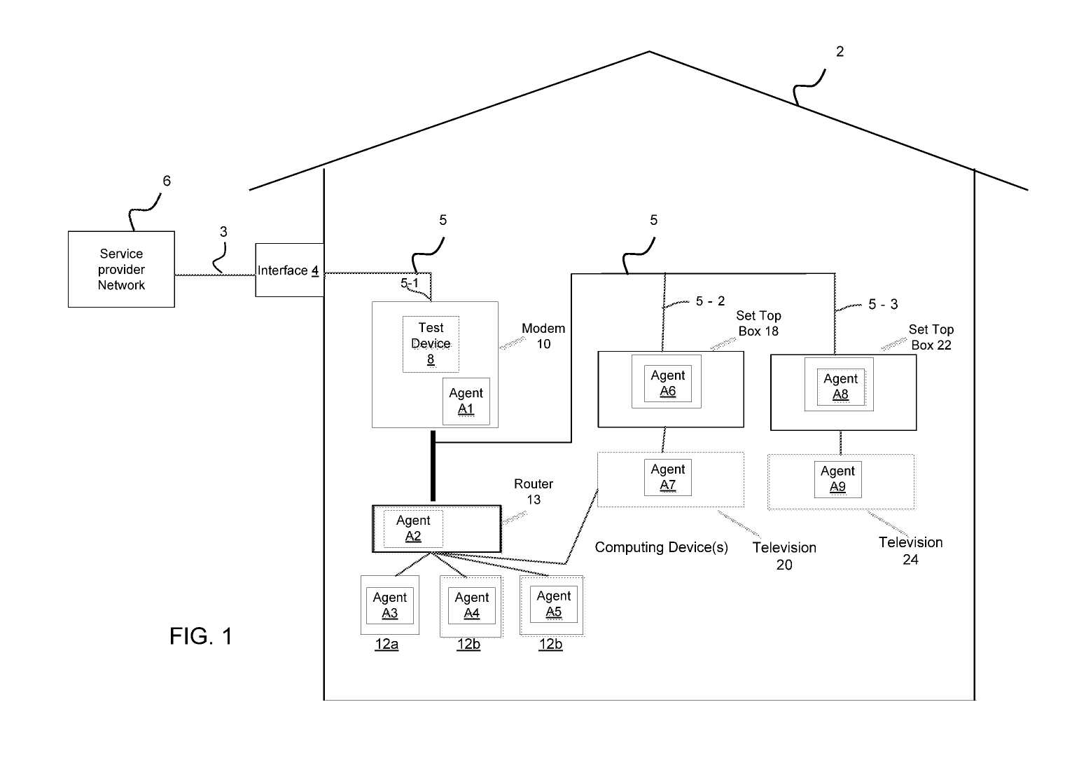

An embodiment of a system in which software agents are installed on communication enabled devices on the customer premises is shown in FIG. 1. FIG. 1 schematically illustrates an example of customer premises 2, which in this example is illustrated as a building, which may be a residence or other structure. The customer premises 2 is provided with one or more communication service(s), such as cable television service, cable internet service, telephone service and/or DSL (Digital Subscriber Line, WiMax, LTE or other broadband wireless service which comes in multiple forms, such as ADSL and VDSL) service by service provider network 6 via one or more wired external conductors 3 or wireless communication devices connected to internal conductors 5. External conductors 3 and internal conductors 5 may be any suitable types of electrical conductors, such as wires or cables. For example, external conductors 3 and internal conductors 5 may be configured to provide cable service (through a coaxial cable, for example) or telephone service (through a twisted pair cable, such as tip-ring pair, for example) and may be formed of any suitable electrically conductive material (e.g., copper). External conductors 3 may be connected to the internal conductors 5 of the customer premises at an optional interface 4. When the internal conductors 5 and external conductors 3 are configured to provide telephone service, interface 4 may be a Network Interface Device (NID), as known in the art. Although interface 4 is illustrated in FIG. 1 as being located on the exterior of the customer premises, in some embodiments, an interface between the internal conductors 5 and external conductors 3 may be located on the inside of the customer premises, or in any other suitable location. Interface 4 is an example of a network demarcation point, which in this example is connected between the internal conductors 5 and external conductors 3 of a building 2. However, it should be appreciated that other types of buildings, such as multi-dwelling premises, may have interfaces located at different network demarcation points within and/or outside of the premises. In some cases, interface 4 may be omitted and the external conductors 3 may be directly connected to the internal conductors 5.

The internal conductors 5 may include extensions 5-1, 5-2 and 5-3. As shown in FIG. 1, a modem 10 may be connected to extension 5-1, a first set top box (STB) 18 may be connected to extension 5-2 and a second set top box (STB) 22 may be connected to extension 5-3. Though, it should be appreciated that FIG. 1 provides just one example of a network architecture. For example, extensions set top boxes 18 and 22 may be connected to router 13, allowing them to exchange digital information with other communication enabled devices on the customer's home network.

The modem 10 may include a test device 8 which may be connected to the internal conductors 5 of the customer premises. One or more computing device(s) 12a, 12b, 12c, etc. may be connected to the modem 10 via a wired or wireless connection, either directly or indirectly through another device, such as a router 13. Any suitable type of wired or wireless communication may be used, such as WiFi or Bluetooth for wireless communication, for example, or Ethernet, USB, FireWire, etc., for wired communication, by way of example and not limitation. Examples of computing devices 12a, 12b, 12c include a personal computer (e.g., a desktop or laptop computer), a tablet computer and a cellular telephone (e.g., a smartphone), by way of illustration. However, any suitable type of computing device(s) may be used.

Router 13 may be any suitable wired and/or wireless router. Router 13 may enable communication between computing device(s) 12a, 12b, 12c and modem 10 as part of a local network (e.g., a home network). Any suitable number of computing devices may be included in the local network. For example, a television 20 may be connected to set top box 18 to receive programming. If television 20 is an IPTV (an Internet Protocol enabled TV), television 20 may be connected to modem 10 (e.g., via router 13), thereby allowing television 20 to receive information packets (e.g., streaming video or other content) from the Internet through modem 10.

As illustrated in FIG. 1, one or more devices at the customer premises may include a software agent for gathering and/or processing diagnostic information to diagnose a service-affecting condition. Each software agent may gather diagnostic information from the device on which it is installed regarding the operation of the device and/or a communication service provided thereto. Diagnostic information, for example, may be accessed through an established programming interface for the communication enabled device. As a specific example, a communication enabled device may have a management interface through which performance information may be obtained and used for diagnosis. Though, any suitable interface techniques may be used to obtain diagnostic information.

In some embodiments, software agents running at the customer premises may be configured to communicate with one another to exchange information, such as diagnostic information, results of processing the diagnostic information and/or to conduct tests that may generate diagnostic information. Alternatively or additionally, the software agents may be configured to communicate with a diagnostic controller, not shown in FIG. 1. As shown in FIG. 1, modem 10 may include a software agent A1, router 13 may include a software agent A2, computing devices 12a, 12b, and 12c may include, respectively, software agents A3, A4 and A5, set top box 18 may include a software agent A6, television 20 may include a software agent A7, set top box 22 may include a software agent A8, and television 24 may include a software agent A9. Each of devices 10, 12, 13, 18, 20, 22 and 24 shown in FIG. 1 to include a software agent is an example of a communication enabled device. However, any suitable communication enabled devices may include software agents, as the techniques described herein are not limited to particular arrangement, number or types of devices illustrated in FIG. 1, as more or fewer software agents may be used, and agents may be included in different types of devices or connected in a different manner. Executable program code for running a software agent may be stored in each device (e.g., in suitable computer storage), and may run on a processor (e.g., a microprocessor) in each device.

Each software agent may gather diagnostic information to diagnose a service affecting condition that may be associated with the corresponding device or a communication service provided thereto. For example, software agent A6 may obtain packet loss and/or packet latency information regarding video packets sent to set top box 18. Though, there is no requirement that each agent be limited to diagnosing condition with the communication enabled device on which the agent resides. In some embodiments, agents may gather information useful in diagnosing conditions associated with other devices.

In some embodiments, each agent may process the diagnostic information obtained from the device on which the agent is run. Such processing may result in a determination that a service affecting condition exists, generate information about the service affecting condition and/or provide information about correcting the service affecting condition. For example, agent A6 may perform diagnostic processing on the obtained diagnostic information obtained by agent A6 from set top box 18. Alternatively or additionally, software agents may send the diagnostic information to another device for processing. For example, software agent A6 may send the obtained diagnostic information to another software agent for processing, such as software agent A1 running on modem 10. In some embodiments, each agent may provide the obtained diagnostic information to a centralized processing location, such as a diagnostic controller. The agent may be configured to initiate such a transfer of diagnostic information or may respond to a request from a centralized processing location to provide diagnostic information. For example, each agent may send diagnostic information to a selected agent (e.g., agent A1) for processing. To facilitate communication between agents, some or all of the agents, including the diagnostic controller, may be compatible with existing technologies such as TR-069, LSBBT, and/or a Network Analyzer control protocol.

Accordingly, in some embodiments each agent may perform one or more of the following tasks:
a. Collect and report diagnostic data periodically to a control agent.
b. Analyze data to determine whether a service affecting condition exists and report service affecting conditions to a control agent.
c. Run on-demand diagnostic test in response to a request from another agent, such as a control agent.
d. Inform/Display service affecting conditions and recommended actions to end user via LEDs, on-screen display, audio alarm or other user interface on the device on which the agent is executing.
e. Reset the device on which the agent is executing.
f. Execute a protocol to automatically discover another device connected to the customer premises network operating as a control agent. Devices may alternatively or additionally participate in a negotiation such that, if more than one device is capable of acting as a diagnostic controller, in some embodiments, a single diagnostic controller may be selected.
g. Collect and Report Data mining of user activity: channels watched (in the case of an internet TV, set top box or other capable of presenting information on multiple channels from which a customer may select). In conjunction with channel information, the agent may collect and report other information, such as timestamp and duration.
h. Maintain a “watchdog timer” on software applications or other components within the device on which the agent is executing. The watchdog timer, for example, may be implemented as a component that detects initiation and termination of functions or processes, under hardware or software control, on a device.

Further, in some embodiments, one or more of the software agents may have the ability to control an operating state of the communication enabled device on which it is executing. For example, an agent may accept and respond to commands to resent the device or change a setting on the device. Such an operation may be undertaken in response to detecting a misconfiguration or improper operating state of the device by the agent or an agent on another device. Though, such a capability may alternatively or additionally be used in other ways, such as part of a diagnostic sequence.

One or more of the agents (e.g., agent A1) may act as control agent for the network, acting as a diagnostic controller by controlling or coordinating operations of the other agents in the network. The control agent may be installed on any suitable device in the network, such as a communication enabled device, a residential gateway, modem, etc. The agent may run on any suitable operating system or platform such as ANDROID, IOS, MAC OS, LINUX, WINDOWS, or a JAVA virtual machine, for example. Accordingly, in some embodiments, the control agent may be installed on a user computing device, such as a desktop, laptop or tablet computer or other device with computing power such as a smartphone.

Agents running on one or more other devices may identify service-affecting conditions, obtain diagnostic information from their respective devices and send it the diagnostic information to the control agent for processing.

In some embodiments, agents may perform tasks, including one or more of the following, instead or in addition to tasks described elsewhere herein:
a. Collect and report diagnostic data periodically to control agent b. Report service affecting conditions to control agent
c. Run on-demand diagnostic test as requested by control agent
d. Inform/Display service affecting conditions and recommended actions to end user via LEDs, on-screen display, audio alarm, and/or other input/output mechanisms of the device on which the agent is executing
e. Reset the device
f. Automatically discover a control agent on the home network to which the agent is attached.
g. Collect and Report Data mining of user activity, such as: channels watched, timestamp, and duration

The control agent may be responsible for performing at least a portion of diagnostic processing to identify the cause of the service-affecting condition, and may also report other data it generates or collects from other agents to the service provider. In some embodiments, the control agent may perform one or more of the following tasks, instead or in addition to tasks described elsewhere herein.
a. Collect real time status. Status may be collected for network elements such as LAN side network connected devices, connection paths, connection types, connection status, bandwidth consumption, resources shared of each device: WiFi, (and 802.11e), Ethernet, MOCA, HPNA, WHDI, WiGig.
b. Collect real time statistics. Statistics may be collected for network functions such as LAN side network connections via deep packet inspection to determine traffic types, (UDP, HTTP, SIP, RTP, RTSP, POP, SMTP, FTP, SSL) bandwidth utilization, jitter, latency, retransmissions, and packet loss of each
c. Collect real time status of gateway communications. These communications may be performed using a protocol compatible with the network gateway. For example, these communications may be via TR-064, or SNMP RFC2669 and RFC2670 capability for telecoms or cable service providers as appropriate
d. Issue commands for an interface device or other device. Such commands may include a soft reset command or a command to execute home wiring test functionality. These commands may be issued using a protocol compatible with the device. For xDSL served customers, these may be TR-064 commands. Alternatively or additionally, commands may be issued for agents on devices with user interface functionality to display information to the customer and/or obtain customer input. Information displayed for the customer may include, for example, status or steps the customer may take to aid in diagnosing or to correct a service-affecting condition.
e. Determine the status of the wide area network, which may be the service provider's network. Status parameters collected may include connection types, connection status, bandwidth availability, recent changes in bandwidth, visibility into flows 802.1 p/q.
f. Conduct speed tests. These tests may be back into a wide area network to which the customer's premises network is connected. The wide area network, for example, may be the service provider's network. These tests may be performed by interaction with devices in the wide area network and measuring the speed at which data is transmitted. Speed tests may alternatively or additionally be performed on the customer's premises network by interaction with devices on the customer premises network.
g. Communicate with a centralized manager that may also interact with other control agents in other customer premises networks. The centralized manager may be a test device, such as those sold under the name of 4Tel or Loopcareor TR-069 Manager. Those test devices may perform tests and otherwise collect diagnostic information relating to service affecting conditions on the service providers network, such that the centralized manager has network wide visibility in the service provider's network. Communications to the centralized manager may include diagnostic information collected by other agents and/or may include results of diagnostic analysis. Such communications may enable the service provider operating the centralized manager to better diagnose problems in the service provider network. Alternatively or additionally, by providing information about current service affecting conditions in the service provider's network, control agents may better identify problems in the customer premises network. For example, when notified of immediate or potential problems from other software agents, the control agent may begin problem analysis by first checking with the centralized manager to see if the problem is originating in the WAN network. If so the control agent may alert the customer as to source of problem.
h. Perform analysis on data from agents, the centralized manager, customer inputs, and/or other sources to detect, localize and/or identify corrective actions for such conditions.

In this context, “real time” implies that delay between a measurement and information being available at the control agent is small enough that the control agent has access to information indicative of a service affecting condition while that condition is, from the perspective of a customer, ongoing or has just occurred. As a result, if a customer has experienced poor performance as a result of that condition, the control agent can process that information while the poor performance is still of relevance to the customer. Status or statistics may be collected in any suitable way. In some embodiments, this information may be collected by the control agent polling agents on other devices, prompting them to send information. In other embodiments, the agents on other devices may be programmed to periodically, and/or in response to detected events, report information to the control agent. Such detected events may include detected abnormal conditions and/or changes in conditions. Communications with a centralized manager may similarly be periodically initiated by the control agent, event driven or in response to a request from the centralized manager.

In some embodiments, tasks described herein as being performed by a control agent may be performed by one or more other agents on the network (e.g., in a distributed manner) and/or by one or more devices in the service provider network 6.

In some embodiments, diagnostic information alternatively or additionally may be sent to the service provider network 6 for processing. For example, each device may send diagnostic information to agent A1 (or another selected agent) so that agent A1 may transmit the diagnostic information from the agents, or a result derived from processing information from the agents, to the network 6 for processing. Alternatively or additionally, each agent may be configured to exchange information with the service provider network 6. If the diagnostic information is processed by the service provider network 6, the service provider network 6 may send a result to one or more agents on the customer premises, such that the result may be provided to the customer and/or additional action may be taken, such as performing one or more tests. In some embodiments, one or more agents may send other information to the service provider network 6 for processing, such as a test result, for example. Such information may be sent to the service provider network 6 along with diagnostic information, or sent separately, as the techniques described herein are not limited as to the timing with which information is exchanged.

Diagnostic information may include any suitable information regarding the operation of the device or a service provided thereto. In some embodiments, communication between the communication enabled devices may be performed using a suitable packet-based communication protocol. For example, the communication-enabled devices may communicate with one another using a wired or wireless packet based network protocol, such as Ethernet, WiFi, Bluetooth, etc. As another example, devices connected via conductors (e.g., internal conductors 5) may communicate using a protocol such as MoCA, HPNA, G.hn, etc. Diagnostic information may include information regarding a measured performance of protocol-based communications used to communicate between the communication enabled devices. Obtaining diagnostic information regarding protocol-based communications between communication enabled devices at the customer premises may allow a diagnosis to be performed based on segments of the local network. The diagnostic information can be processed to identify which segment of the local network is the cause of a service-affecting condition.

Any suitable communication-enabled devices can be provided with a software agent, such as desktop and laptop computers, tablet computers, smart phones, set-top boxes, IP enabled TVs, IPTV access devices, MOCA-compatible devices, HPNA-compatible devices, PicoCells or FemtoCells for cellular communication, routers, Ethernet hubs, modems, smart appliances, gaming devices, Internet radios, Wi-Fi access points etc, by way of example and not limitation. Including software agents in such devices may facilitate comprehensive diagnosis of service affecting conditions.

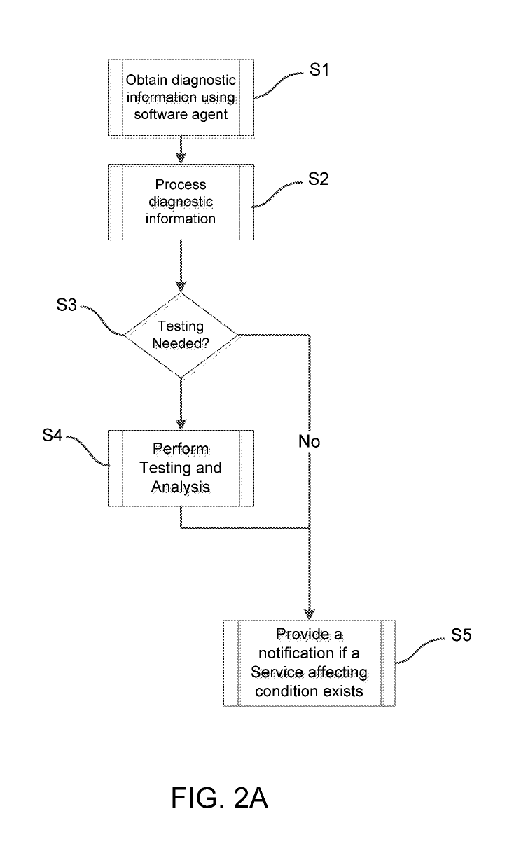

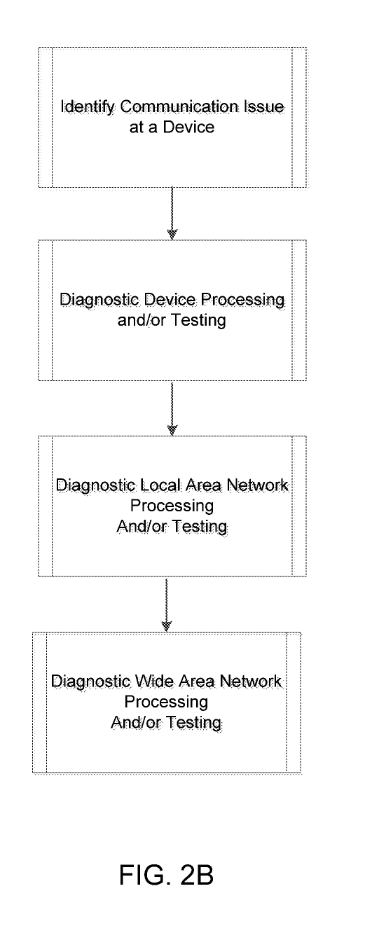

FIG. 2A shows a flowchart of a method of a method of diagnosing a service affecting condition, according to some embodiments. This step may be initiated in response to user input through a user interface linked to a software agent or may be initiated periodically under control of a software agent. Such user input may expressly request a test or may indicate that the user has perceived a service affecting condition, which may serve as on indirect request for diagnosis of the cause of a service affecting condition.

Regardless of how the method is initiated, in step S1, diagnostic information may be obtained using a software agent. For example, as discussed above, one or more software agents installed on respective one or more communication enabled devices may obtain diagnostic information regarding the communication enabled device and/or a service provided thereto. In step S2, the diagnostic information obtained by the one or more software agents may be processed. Processing the diagnostic information can enable determining whether a service affecting condition is caused by one or more of the communication enabled devices on the customer premises. Though, it should be appreciated that agents may perform processing that determines any suitable source of a service affecting condition.

As discussed above, the processing may be performed by an agent designated as a control agent or any one or more of the software agents and/or by a dedicated test device or other computing device within the service provider network. In some embodiments, the processing may be done within a computing device attached to the network.

In step S3, a determination may be made as to whether testing, or other data, is needed to diagnose the service-affecting condition. If not, and a service affecting condition has already been diagnosed based on the diagnostic information, a notification may be provided to the customer and/or service provider in step S5. If testing is needed, a test is performed or other data gathering actions may be performed in step S4. For example, protocol-based communication between devices in the local network and/or communication with a device outside of the local network (e.g., on the Internet) may be performed. As another example, electrical testing on conductors within or outside of the customer premises may be performed. Any suitable type of testing may be performed, examples of which are described below. Moreover, data may be gathered from any one or more agents, and such data may include information about network and/or device operating condition as well as diagnostic data.

Analysis of the test results and other data may be performed to determine a service affecting condition based on the test results and/or the diagnostic information. If a service affecting condition is determined, a notification may be provided to the customer and/or service provider in step S5. The notification may be provided through a device determined to be faulty, through a user interface of a device executing a control agent or any other suitable device with a user interface.

The steps of the method illustrated in FIG. 2A may be performed in any suitable order, as the techniques described herein are not limited as to the order of steps illustrated in FIG. 2A. For example desired testing may be performed prior to processing the diagnostic information. The diagnostic information may be processed (i.e., analyzed) together with a test result. In some embodiments, testing and/or analysis may be performed on an ongoing basis (i.e., at regular intervals), to facilitate early detection of a potential or actual service affecting condition, before the customer requests assistance.

In some embodiments, when a service-affecting condition is detected by an agent A, a rule-based approach may be used to isolate and identify the cause of the service-affecting condition. FIG. 2B shows a method of diagnosing a service-affecting condition, according to some embodiments. In a first step, a service-affecting condition, which may be the result of a problem in communication, may be identified. Such a communication issue may be identified at a device on the customer premises. In an exemplary scenario, agent A6 running on set top box 18 may determine that a video quality issue is occurring. After the communication issue is identified, diagnostic device processing and/or testing may be performed related to the device (e.g., set top box 18) for which the communication issue has been identified and/or other devices that could contribute to the service-affecting condition or could provide information useful in diagnosing the service-affecting condition.

In a case where a device from which information is to be collected includes a set top box, a controller in the set top box 18 may check diagnostic information relating to the set top box, such as the amount of processor utilization (e.g., MIPS utilization), the amount of available memory, etc. If the amount of processor utilization or available memory is below a threshold, the software agent is notified. The controller may continue to check, at predetermined intervals (e.g., 1 second), for a period of time (e.g., a predetermined number of seconds). If the amount of processor utilization or available memory stays below the threshold, the controller may notify the software agent A6 that an error has occurred. The software agent may display an error message indicative of the problem to the user and/or may report the problem to the service provider network 6. The controller may request permission from the software agent 6 to restart the set top box 18. If the amount of processor utilization or available memory rises above the threshold, information indicating that the problem is resolved may be presented to the user and/or sent to the service provider network 6. If the problem is not due to lack of critical resources in the set top box 18, the controller may check whether the number of video quality faults reported within a recent time interval exceeds a configured threshold. If the number of video quality faults does not exceed the threshold, the controller may log the event and check whether other agents have reported quality issues within the recent time interval. If the number of video quality faults exceeds the threshold, or if other agents are reporting issues within the recent time interval, a fault isolation process may be started. The controller may also make a log of each of these events locally at the set top box 18.

The fault isolation process may begin with obtaining of diagnostic information from the agents in the network. For example, information may be obtained regarding communication quality, such as internet protocol statistics regarding the local area network, e.g., the number of packets lost, the number of packets having an error, and/or the average ingress and egress queue sizes, or any other suitable diagnostic information. The diagnostic information may then be analyzed. For example, the diagnostic information may be compared with a threshold to determine whether communication quality is acceptable.

If the diagnostic information indicates sub-optimal performance of the local area network, this information may be reported. For example, a message may be sent to the other software agents in the local network, a local area network interface (e.g., modem 10 and/or router 12), and or the service provider network 6. When the local area network is performing sub-optimally, corrective action may include re-setting the local area network (e.g., by resetting modem 10 and/or router 12). The software agents may prepare their respective devices for a network reset. In some cases, the software agents may notify a user that the network is about to be reset. The local area network interface may then reset the local area network.

If the diagnostic information does not indicate sub-optimal performance of the local area network, diagnostic information regarding the performance of communications with service provider network 6 (e.g., DSL or cable broadband service) may be obtained. Any suitable information regarding the performance of communications may be tested. For example, such diagnostic information may include internet protocol and/or key performance indicators, round trip delays (e.g., average round trip delays to predetermined servers), etc.

If the diagnostic information indicates the performance of communications with service provider network 6 are sub-optimal, notification may be provided to one or more agents, to the user, and/or to the service provider network 6. For example, a notification may be provided to agent 6 to inform the user of the problem. Agent 6 may request permission from the user to perform a wide area network diagnostic test. If permission is requested and received, wide area diagnostic tests may be performed such as connectivity tests or tests of physical wiring or other conductors within or outside of the home. If a service affecting condition is identified within the customer premises, the user and/or the service provider network may be notified of the problem. The user may be provided with additional information for correcting the problem or pinpointing the root cause, or may be notified to contact the service provider for assistance. If a service affecting condition is identified within the service provider network, the user and/or the service provider network may be notified of the problem. The user may be notified to contact the service provider for assistance.

If the diagnostic information does not indicate sub-optimal the performance of communications with service provider network 6, the steps of obtaining diagnostic information regarding the performance of communications with service provider network 6 and wide area network diagnostic testing may be repeated. If performance is acceptable the fault isolation process may terminate, as the process of performing wide area network diagnostic testing may have addressed the issue due to restarting and/or resynchronizing of components.

In some cases, communication with the service provider may be initiated to determine whether any known issues with the service provider network exist, such as a problem with a video head end, an over-loaded video-on-demand server, or a problem with an inbound video feed. If so, the information may be provided to agent 6 to notify the user by displaying an error message. For example, the error message may state “We are aware of a network problem in your area and are working to restore service. We expect service to be restored in XX minutes.” If performance is not acceptable, and the cause cannot be determined, the user may be notified to contact their service provider for assistance.

In some embodiments, testing to determine physical network parameters may be performed in response to processing performed on the diagnostic information collected by an agent executing at a communication enabled device. For example, a test device 8, as shown in FIG. 1, can test wires (or other electrical conductors) carrying service at the customer's location, including conductors on the customer premises and/or outside of the customer premises (e.g., in the service provider network) to enable detecting faults or other problems that may cause a service disruption. Such a device may support multiple operating modes to facilitate multiple modes of identifying conditions that could create service problems, for current or possible future services. Although FIG. 1 shows an example in which the test device 8 is included in a modem 10, test device 8 may be integrated into another device or implemented as a stand-alone device. Regardless of the construction and operation of test device 8, test device 8 may be triggered to perform one or more tests to obtain diagnostic information in response to a command from an agent installed in a communication enabled device. Such a command, for example, may be sent in response to detecting a condition that is likely to cause a user of the communication enabled device to experience degraded service.

Any suitable test device may be used for this purpose. The test device may make any of a variety of measurements and generate any of a variety of test signals. Supported measurements may include measurements of wireless signal strength or electrical properties of the conductors themselves. These measurements may be used to determine conditions of conductors, such as shorts, opens or conditions causing imbalance of conductors used as a differential pair. These measurements may also be used to determine operational state of conductors, such as whether the conductors are actively being used to provide telephone service or data service.

Other measurements may reveal energy at different frequencies. Such a capability may be used, in combination with an ability to determine whether a line is actively in use, to measure quiet line noise or to detect a missing microfilter. Alternatively or additionally, such a capability may be used in combination with an ability to generate test signals (e.g., stimulus signals) at a range of frequencies to perform frequency domain reflectometry measurements, which can aid in determining a location of a fault. As a further example, such a capability may be used to determine whether signals in accordance with a protocol, such as DSL, are being received, which can be used to detect or localize faults.

Such a test device may be triggered to perform tests in one or more ways. The test device, for example, may be triggered based on processing of diagnostic information obtained from one or more software agents. For example, agent A1 running on modem 10 (or another selected agent) may trigger test device 8 to perform a test in response to determining, based on the obtained diagnostic information, that a test is needed to diagnose a service affecting condition. Alternatively or additionally, the test device may be activated by the customer, e.g., by the push of a button. Alternatively or additionally, the test device may be activated by an external computing device.

The external computing device may be a computing device, such as device 12, operated by the customer. Such a computing device may be programmed to control the test device to perform a diagnostic sequence aimed at identifying faults in conductors on the premises. In some embodiments, a control agent may execute on the computing device, and may control the diagnostic operations. The diagnostic sequence may include instructions for the user to take action that can aid in diagnosing or, in some scenarios, resolving service-affecting conditions within the customer's premises. Though, in some embodiments, the diagnostic sequence may be entirely automated such that a service affecting condition may be detected without requiring any express user input. In some embodiments, the external computing device that triggers one or more tests may be a modem, router, residential gateway or other customer premises equipment such as a set top box, television, personal computer, tablet computer, smartphone or other device.

Alternatively or additionally, the external computing device may be a computing device operated by the service provider within the service provider network 6. The external computing device, for example, may be a component of a test system that is testing a line used by a customer having the test device. Interactions between the service provider test system and the test device on the customer premises may better diagnose a fault and determine its location than either the test system or test device alone. Alternatively or additionally, the external computing device may be a computing device managing interactions with a customer that has contacted the service provider for assistance in resolving a problem with service.

In such a scenario, the external computing device may trigger the test device to perform tests or to provide the results of tests. Though, it is not a requirement that the external computing device trigger either the generation or transmission of test results by the test device. The test device, for example, may be programmed to initiate communication with the external computing device based on measurements made in performing a test or may be triggered to initiate communication based on user input or other factors.

Alternatively or additionally, in some embodiments, a customer may obtain the test result through the user interface and input the test result to an external computing device, such as the customer's computing device 12. In this way, the external computing device may provide the customer with additional information regarding the test result and/or troubleshooting information. In this manner, detailed guidance may be presented to the customer to assist the customer to resolve the problem.

In some embodiments, a dedicated test device performs measurements using test hardware dedicated for network testing. In contrast, an agent may collect diagnostic information using only hardware installed at a customer premises for delivering a communication service. However, such a distinction between a dedicated test device and a communication enabled device in which an agent is installed is not a requirement. In some embodiments, an agent may be installed in a device that includes test hardware and/or a test device may be integrated with a device that delivers the communication service.

The following is a list of examples of diagnostic information that may be obtained and/or analyzed to diagnose problems with video that may occur on a set top box.

Set Top Box Video

Video Quality Analysis
a. Video quality analysis for all channels, Analog, MPEG2, MPEG4, ATSC, DVB
b. Packet inspection for buffer underruns, dropped packets, out of order packets, type of packet loss: I, P, B frames, MOS score, screen freeze, black screen, pixelization
c. Quality degradation scope: one channel, a few channels, all channels
d. Content aware QOE analysis—sports vs. news
e. Bandwidth utilization and contention from each software app on the LAN
f. Layer 1/2 analysis of MOCA, HPNA, WHDI, WiGig performance
g. Interrogation of Gateway to determine WAN integrity
h. Automatic On-screen display notifying customer of trouble, and resolution steps

DVR
a. Response time analysis of remote control keys with menu—customer frustration analysis (keystroke scrutiny)
b. Menu lockup detection
c. Video responsiveness to remote control key strokes; trick play, stop/start
d. File system integrity
e. Video playback quality, buffer underruns, pixelization, MOS score, screen freeze, black screen
   a. Layer 1/2 analysis of MOCA, HPNA, WHDI, WiGig performance
f. Whole house DVR functionality
   a. Layer 1/2 analysis of MOCA, HPNA, WHDI, WiGig performance
g. Automatic On-screen display notifying customer of trouble, and resolution steps

On Screen Menu
a. Response time analysis of remote control keys with menu—customer frustration analysis (keystroke scrutiny)
b. Menu lockup, black screen, slow update detection
c. Video responsiveness to remote control key strokes; channel up/down, volume
d. Menu agility—handset keystroke overrun
e. Automatic On-screen display notifying customer of trouble, and resolution steps

On Demand Services
a. Response time analysis of remote control keys with menu—customer frustration analysis (keystroke scrutiny)
b. Menu lockup, black screen, slow update detection
c. Buffer underuns, video quality, pixelization,
d. Video responsiveness to remote control key strokes; trick play, stop/start
e. Menu agility—handset keystroke overrun
f. Automatic On-screen display notifying customer of trouble, and resolution steps
g. Automatic troubleshooting to determine contributing source of the problem: network server, bandwidth congestion, noise, provisioning

The above information may be collected from an agent in a set top box. In this context, a set top box may be any device that controls display of programming through an audio-video display device, such as a television. It should be appreciated, though, that such a box need not physically reside on top of a television set. Rather, such functionality might be integrated into the television itself or any other suitable electronic device.

Information may be collected from a set top box as a result of periodic monitoring, allowing problems to be detected without express user input. Alternatively or additionally, the above information may be collected in response to user input or response to measuring one or more parameters at any point in the network that could be indicative of a service-affecting condition. For example, some or all of the above information may be collected in response to user input indicating problems such as problems with:
a. Video Quality
b. On Screen Menu
c. On-Demand
d. DVR

Other types of problem reports, or problems detected as a result of monitoring user action and/or network performance, may include:
a) Slow Internet
b) No Service
c) E-Mail
d) Device Networking
e) Malware

Such conditions may be reported directly or may be reported by a customer describing symptoms of such problems, including slow or no internet service, problems sending or receiving e-mail or communicating with devices in the network. In response to detecting such service-affecting conditions, diagnostic tasks may be performed by one or more agents, including one or more of the following:
a. Verify connectivity to the residential gateway
b. Collect LAN and WAN statistics from residential gateway via TR-064
c. Collect LAN statistics from all devices as home
d. Collect near real time statistics of LAN side network connections via deep packet inspection to determine traffic types, (UDP, HTTP, SIP, RTP, RTSP, POP, SMTP, FTP, SSL) bandwidth utilization, jitter, latency, retransmissions, and packet loss of each
e. Run IP level/Application level tests such as ping test, speed test, FTP test etc
f. Run DSL diagnostic test TR.064
g. Reset DSL modem via TR.064

### Discussion of an Exemplary Network Structure

As illustrated in FIG. 1, modem 10 may communicate with the service provider network 6 via the internal conductors 5 and external conductors 3. In some embodiments, the modem 10 may be a customer's cable modem or a customer's DSL modem.

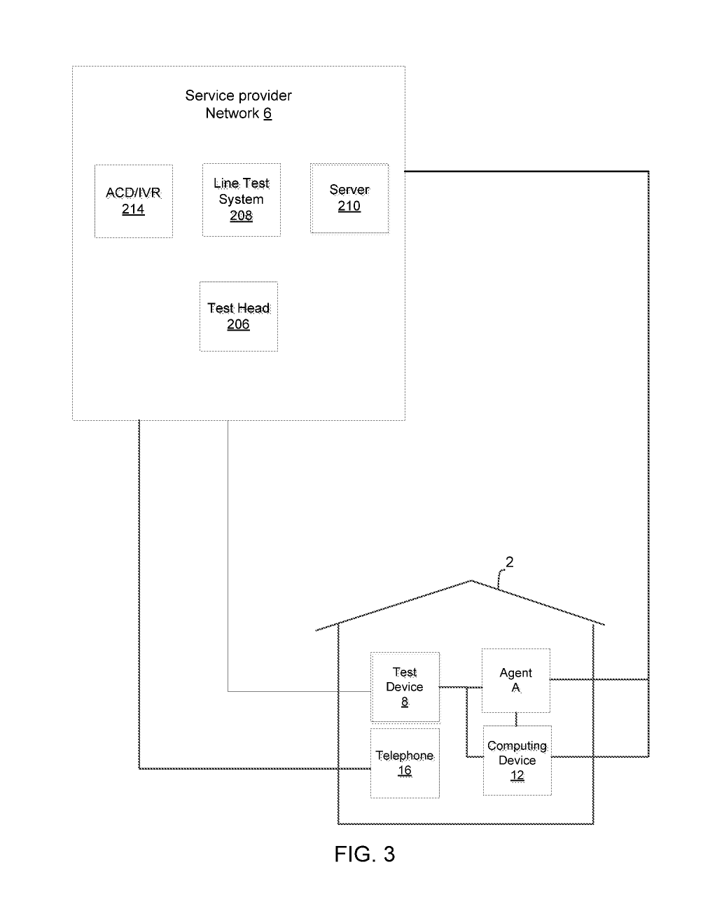

FIG. 3 shows a diagram of a system in which the test device 8 and/or a software agent A may communicate with one or more other devices to provide additional functionality to aid in testing to detect or troubleshoot service affecting conditions. For example, as illustrated in FIG. 3, the test device 8 may communicate with an agent A running on a communication enabled device (such as agent A1, for example). Test device 8 and/or agent A may communicate with a computing device 12 (e.g., device 12a, 12b and/or 12c, etc.) in the customer's structure. Since, in some embodiments, the customer's computing device 12 may facilitate providing information to the customer regarding a diagnosis determined based on processing of diagnostic information and/or a test result. For example, once a diagnosis is made, it may be provided to computing device 12 by agent A or the service provider network 6. The computing device 12 may use the diagnosis to provide the customer with information regarding the diagnosis and/or corrective action to be taken. Advantageously, the computing device 12 may provide troubleshooting information to assist the customer in resolving the problem.

In some embodiments, the test device 8 and/or agent A may communicate with the service provider network 6 to exchange test data and/or control commands. For example, the test device 8 may be configured to receive a command from the service provider network 6 to initiate a test. Such a technique may be used in a variety of scenarios. For example, if a customer is having a problem with their service, the customer may call the service provider (e.g., using telephone 16 or a cellular telephone). The customer's call may be handled by an Automated Call Distribution/Interactive Voice Response System (ACD/IVR) 214. ACD/IVR system 214 may be implemented using techniques as are known in the art. Though, it may be programmed to interact with test device 8 and/or one or more agents in communication enabled devices installed at a customer's premises.

To assist in resolving the problem, the ACD/IVR system 214 may interact with test device 8 and/or agent A. In a scenario in which a customer has called ACD/IVR system 214 using a telephone on the customer premises, there may already be a connection, using the telephone service such that the interaction may occur over a telephone line. In some embodiments, that interaction may be performed using signaling tones designated for communications between the test device 8 and a remote computing device.

That interaction may include sending a command to the test device 8 to cause test device 8 to provide test results. The command may initiate an electrical test on the conductors of the customer premises and/or may trigger test device 8 to provide results of a most recently performed test.

This information may be used by the ACD/IVR system 214 in any suitable way. For example, the information may be used as part of an automated diagnosis technique. Test results from test device 8, reflecting a condition of conductors in a customer's premises, for example, may be used to localize a service affecting condition to either the service provider's network or the customer's premises. The test results also may be used to rule in or rule out problems, either in the premises or within the service provider network. The test results also may be used to confirm a diagnosis or increase the confidence in a conclusion as to the source or location of a condition affecting service.

Alternatively or additionally, the test results may be used by ACD/IVR system 214 to direct the service flow. For example, ACD/IVR system 214 may be programmed to prompt a customer for more information when test results from a test device within a customer's premises are not available than when results are available. As a specific example, if a quiet line noise measurement is available from test device 8, ACD/IVR system 214 may be programmed to omit questions prompting a customer to provide information about problem symptoms that might reveal a noise source creating interference with digital data services, but to ask those questions otherwise. As yet another example, if test device 8 is programmed to test for missing microfilters within the customer's premises, and if the test results indicate that missing microfilters were detected, ACD/IVR system 214 may present to the customer instructions for obtaining and installing microfilters,

As yet a further use of such data, it may be used to condition access to a human service representative or to otherwise prioritize service provided to a customer. Because of the high cost to a service provider of making a human service representative available to a customer, a service provider may prioritize such access to those customers most likely to be experiencing problems with the service provider's network, and not problems within their own premises. Alternatively or additionally, including a step in a service flow that requires or encourages customers to conduct a test with a test device on their premises promotes diagnosis by a human customer service representative that has better information on which to diagnose a customer's problem. Having test results passed to ACD/IVR system 214 or other suitable computing device that is part of the service provider's network may provide the customer service representative with additional information, not available by asking questions of the customer. Moreover, in some scenarios, information provided by a test device may be more reliable than comparable information provided by a customer. A customer, for example, may inadvertently provide incorrect information or may make up information, thinking that doing so will expedite the service process.

As yet a further use of data from test device 8, ACD/IVR system 214 may use that data to provide the customer with information regarding a test result (e.g., a test result code), diagnosis information and/or troubleshooting information to aid the customer in resolving the problem. Such information may be provided to the user in a variety of ways, such as through automated speech generated by ACD/IVR system 214. As another example, information may be communicated in digital form for display on the test device 8, such as in the form of a test result code. In another example, a customer's computing device 12 may receive the test result and/or additional information from the server 210 or another computing device within the service provider network 6, for presentation to the customer. Though, it should be appreciated that any suitable device may be used to output such information. For example, in a scenario in which the test device is embedded within a set top box (18, FIG. 1), or otherwise connected to a television, the information may be presented as text, graphics or audio-video information on the television or another display device separate from a computing device. In some embodiments, an agent installed in a communication enabled device may be programmed to provide such information to a user. In such a scenario, the agent may control a user interface of the communication enabled device in which it is installed and/or interact with another agent, in another communication enabled device, to have that other agent present the information through a user interface coupled to the other communication enabled device.

It should be appreciated that, though ACD/IVR system 214 provides one mechanism by which test device 8 may interact with a component in the service provider's network, other modes of interaction may alternatively or additionally be supported. In another exemplary scenario, when a service problem occurs, the customer may go online to obtain assistance from the service provider via the Internet. For example, the customer may visit the service provider's web site using a web browser or may use an application program (i.e., an “app” for a smart phone, tablet P.C., or other device) that enables the customer to exchange information with the service provider over the Internet. To do so, the customer may use computing device 12 to communicate with a server 210 of the service provider network 6. As an example, if the customer is having a problem with their service that prevents access to the Internet through the service provider (e.g., DSL service), the customer may access the Internet using another medium, such as a cellular data connection, for example. The customer may thereby communicate with the service provider network 6 (e.g., via server 210) to request assistance. In one example, the service provider may provide assistance through the exchange of messages (e.g., using a chat session), or using any other suitable technique. In the course of providing assistance to the customer, the service provider network 6 may exchange information with the test device 8 and/or agent A. As in other embodiments, the information exchanged may include a command to control operation of the test device and/or test data, as discussed above.

In some embodiments, interaction between the test device 8 and/or agent A and the service provider network may entail exchange of information for the purpose of detecting or localizing service-affecting conditions within the service provider network and/or within the customer's premises. In such a scenario, the “information” exchanged may serve as test signals that may be generated or measured at either test device 8 or a computerized device within the service provider network. Such testing may allow for double-ended measurements, such as may be used to detect shorts or opens or to determine attenuation at various frequencies or other parameters of a line.

Additional Aspects

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, embodiments of controllers may be implemented using hardware, software or a combination thereof. When implemented in software, the software code can be executed on any suitable hardware processor or collection of hardware processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed to perform the functions recited above.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method of diagnosing a service affecting condition, the method comprising:
(A) obtaining first diagnostic information from a first software agent installed on a first communication enabled device within a customer premises and second diagnostic information from a second software agent installed on a second communication enabled device within the customer premises; and
(B) processing the first and second diagnostic information to determine information regarding a service affecting condition.

2. The method of claim 1, wherein (B) comprises processing the first and second diagnostic information to determine information regarding a service affecting condition affecting a communication service provided at the customer premises.

3. The method of claim 2, wherein (B) comprises processing the first and second diagnostic information to determine information regarding communication between the first communication enabled device and the second communication enabled device.

4. The method of claim 1, wherein (A) is performed by a third software agent installed on a third communication enabled device within the customer premises.

5. The method of claim 1, wherein (B) is performed by a third communication enabled device within the customer premises or by a fourth communication enabled device in a service provider network.

6. The method of claim 5, wherein (B) is performed by the third communication enabled device, and wherein the third communication enabled device operates as a diagnostic controller that performs diagnostic tests and/or controls the first and second software agents to perform tests.

7. The method of claim 1, further comprising:
(C) in response to (B), triggering a test of a local network at the customer premises; and
(D) processing a result of the test to determine further information regarding the service affecting condition.

8. The method of claim 1, further comprising:
(C) providing a notification to a customer regarding a diagnosis of a service affecting condition.

9. The method of claim 1, wherein the first diagnostic information is obtained through a programming interface for the first communication enabled device.

10. The method of claim 1, further comprising:
(C) triggering a test of a local network at the customer premises in response to detection of a quality of streaming video received over a communication network,
wherein the first communication enabled device controls display of the streaming video to be performed and the second communication enabled device provides packets of the streaming video to the first communication enabled device.

11. The method of claim 10, wherein the second communication enabled device comprises a modem and/or a router.

12. The method of claim 1, further comprising:
(C) triggering a test of a local network at the customer premises in response to a measured communication parameter.

13. The method of claim 12, wherein the measured communication parameter comprises loss, delay and/or jitter.

14. A computer readable storage medium having stored thereon instructions, which, when executed by a processor, perform a method of diagnosing a service affecting condition, the method comprising:
(A) obtaining first diagnostic information from a first software agent installed on a first communication enabled device within a customer premises and second diagnostic information from a second software agent installed on a second communication enabled device within the customer premises; and
(B) processing the first and second diagnostic information to determine information regarding a service affecting condition.

15. The computer readable storage medium of claim 14, wherein (B) comprises processing the first and second diagnostic information to determine information regarding a service affecting condition affecting a communication service provided at the customer premises.

16. The computer readable storage medium of claim 15, wherein (B) comprises processing the first and second diagnostic information to determine information regarding communication between the first communication enabled device and the second communication enabled device.

17. The computer readable storage medium of claim 14, wherein (A) is performed by a third software agent installed on a third communication enabled device within the customer premises.

18. The computer readable storage medium of claim 14, wherein (B) is performed by a third communication enabled device within the customer premises or by a fourth communication enabled device in a service provider network.

19. The computer readable storage medium of claim 14, wherein (A) is triggered automatically, in response to user input, or in response to detection of a service affecting condition.

20. The computer readable storage medium of claim 14, wherein the method further comprises:
(C) in response to (B), triggering a test of a local network at the customer premises; and
(D) processing a result of the test to determine further information regarding the service affecting condition.

21. The computer readable storage medium of claim 14, wherein the method further comprises:
(C) providing a notification to a customer regarding a diagnosis of a service affecting condition.

22. The computer readable storage medium of claim 14, wherein the first communication enabled device comprises a set top box and the software agent comprises a widget that executes on the set top box.

23. A system for diagnosing a service affecting condition, the system comprising:
at least one computing device configured to:
obtain first diagnostic information from a first software agent installed on a first communication enabled device within a customer premises and second diagnostic information from a second software agent installed on a second communication enabled device within the customer premises; and
process the first and second diagnostic information to determine information regarding a service affecting condition.

24. The system of claim 23, wherein the at least one computing device is configured to process the first and second diagnostic information to determine information regarding communication between the first communication enabled device and the second communication enabled device.

25. The system of claim 23, wherein the at least one computing device is within the customer premises or a service provider network.

26. The system of claim 23, wherein the at least one computing device is configured to provide a notification to a customer regarding a diagnosis of a service affecting condition.
